(19) United States
(12) Patent Application Publication
(10) Pub. No.: US 2026/0107211 A1
(43) Pub. Date: Apr. 16, 2026

(54) TERMINAL APPARATUS, BASE STATION APPARATUS, AND HANDOVER CONTROL METHOD

(71) Applicant: 1FINITY Inc., Kawasaki-shi Kanagawa (JP)

(72) Inventors: Katsunari UEMURA, Chiba (JP); Takako HORI, Sagamihara (JP)

(73) Assignee: 1FINITY Inc., Kawasaki-shi Kanagawa (JP)

(21) Appl. No.: 19/408,473

(22) Filed: Dec. 4, 2025

Related U.S. Application Data
(63) Continuation of application No. PCT/JP2023/026709, filed on Jul. 21, 2023.

(51) Int. Cl. H04W 36/36; H04W 52/02; H04W 72/23

(52) U.S. Cl. CPC H04W 36/362; H04W 52/0235; H04W 72/23

(57) ABSTRACT

A terminal apparatus includes: a controller configured to perform control corresponding to a first cell state that is a first mode and a second cell state that is a second mode different from the first mode; and a receiver configured to receive information regarding a second condition that is a condition indicating that a third event condition is no longer fulfilled in a case of a second time at which a predetermined duration has elapsed from a first time from the base station apparatus, wherein the receiver receives a PDCCH notifying of validation of the third event condition from the base station apparatus, and the controller controls to perform evaluation of a first event condition of conditional handover corresponding to the first cell state until a first condition that the PDCCH is received is fulfilled.

### CROSS-REFERENCE TO RELATED APPLICATION

This application is a continuation application of International Application PCT/JP2023/026709 filed on Jul. 21, 2023 and designated the U.S., the entire contents of which are incorporated herein by reference.

### FIELD

The present embodiment relates to a terminal apparatus, a base station apparatus, and a handover control method.

### BACKGROUND

In the 3rd Generation Partnership Project (3GPP) which is a standardization project, as New Radio (NR (also referred to as “5G”)) which is fifth generation mobile communication, technical specifications of communication standards that satisfy requirements of Enhanced Mobile Broadband (eMBB), Massive Machine Type Communications (MTC), and Ultra-Reliable and Low Latency Communication (URLLC) have been studied.

In 3GPP, a technology for network energy savings (NES) has been studied to reduce power consumption on a network side (that is, a base station apparatus and core network equipment) (Non Patent Document 1).

As one of techniques in the NES, Cell DTX/DRX for realizing discontinuous reception (DRX) and/or discontinuous transmission (DTX) in a cell unit has been studied. Cell DTX/DRX is a technology in which a base station apparatus configures an active period and an inactive period (non-active period) in units of cells, and the base station apparatus performs transmission and reception only in the active period and restricts transmission and reception in the inactive period, thereby reducing power consumption (Non Patent Document 1).

In addition, a handover procedure called conditional handover (condition pre-configured handover) for moving a terminal apparatus to another cell when a cell transitions to a power saving mode (NES mode) has been proposed (for example, Non Patent Documents 1 to 3). The NES mode may mean a state of a cell to which the above-described Cell DTX/DRX is applied, or may mean a state of a cell to which another technology contributing to power saving is applied. Note that a cell shutdown (temporary or long-term cell power-off) in which no cell transmission/reception is performed is also regarded as one of the NES modes.

The conditional handover is a technique introduced for the purpose of enhancing the robustness (stability) and the success probability of handover, and is a handover procedure in which handover destination cell (target cell) information and trigger conditions are configured in advance. The terminal apparatus evaluates a pre-configured trigger condition, and initiates a handover procedure to the target cell when the trigger condition is fulfilled.

For example, related arts are disclosed in 3GPP TR 38.864 V18.0.0(2022-12) (Non Patent Document 1), R2-2305461 (Non Patent Document 2), and R2-2306069 (Non Patent Document 3).

### SUMMARY

According to an aspect of the embodiment, a terminal apparatus communicates with a base station apparatus. The terminal apparatus includes: a controller capable of performing control corresponding to a first cell state that is a first mode and a second cell state that is a second mode different from the first mode; and a receiver capable of receiving information regarding a second condition that is a condition indicating that a third event condition is no longer fulfilled in a case of a second time at which a predetermined duration has elapsed from a first time from the base station apparatus. The receiver receives a PDCCH notifying of validation of the third event condition from the base station apparatus. The controller controls to perform evaluation of a first event condition of conditional handover corresponding to the first cell state until a first condition that the PDCCH is received is fulfilled, and perform evaluation of a second event condition of conditional handover corresponding to the second cell state in addition to the evaluation of the first event condition when the first condition is fulfilled.

According to an aspect of the embodiment, a base station apparatus communicates with a terminal apparatus. The base station apparatus includes: a controller capable of performing control corresponding to a first cell state that is a first mode and a second cell state that is a second mode different from the first mode; and a transmitter capable of transmitting information regarding a second condition that is a condition indicating that a third event condition is no longer fulfilled in a case of a second time at which a predetermined duration has elapsed from a first time from the base station apparatus. The transmitter transmits a PDCCH notifying of validation of the third event condition. The controller controls the terminal apparatus to perform evaluation of a first event condition of conditional handover corresponding to the first cell state until a first condition that the PDCCH is received is fulfilled, and perform evaluation of a second event condition of conditional handover corresponding to the second cell state in addition to the evaluation of the first event condition when the first condition is fulfilled.

The object and advantages of the disclosure will be realized and attained by means of the elements and combinations particularly pointed out in the claims.

It is to be understood that both the foregoing general description and the following detailed description are exemplary and explanatory and are not restrictive of the disclosure.

### BRIEF DESCRIPTION OF DRAWINGS

FIG. 1 is a diagram illustrating a configuration example of a radio communication system according to one embodiment;

FIG. 2 is a diagram illustrating an example of a functional configuration of a terminal apparatus according to one embodiment;

FIG. 3 is a diagram illustrating an example of a functional configuration of a base station apparatus according to one embodiment;

FIG. 4 is a diagram illustrating an example of a handover sequence according to one embodiment;

FIG. 5 is a diagram illustrating an example of event evaluation timing of conditional handover according to one embodiment;

FIG. 6 is a diagram illustrating an example of event evaluation timing of conditional handover according to one embodiment;

FIG. 7 is a diagram illustrating an example of event evaluation timing of conditional handover according to one embodiment;

FIG. 8 is a diagram illustrating an example of event evaluation timing of conditional handover according to one embodiment;

FIG. 9 is a diagram illustrating an example of time-based conditional handover;

FIG. 10 is a diagram illustrating an example of a hardware configuration of a terminal apparatus according to one embodiment; and

FIG. 11 is a diagram illustrating an example of a hardware configuration of a base station apparatus according to one embodiment.

### DESCRIPTION OF EMBODIMENTS

When a cell transitions to a power saving mode (NES mode), available radio resources are reduced as compared with a related cell, so that a total traffic amount of the cell or a total number of terminal apparatuses that can be connected at the same time is reduced more than usual. Therefore, when the cell transitions to the NES mode, a quality of service (QoS) request running on the terminal apparatus is not fulfilled, and user experience may be degraded. To alleviate this problem, for example, a terminal apparatus that is performing a low-delay service such as a real-time service preferably performs handover to another cell before the cell transitions to the NES mode.

Meanwhile, since the change to the NES mode is executed regardless of the quality (measurement results, cell quality) of the cell measured by the terminal apparatus, there is a case where the terminal apparatus is not moveable to another cell in a normal handover procedure. For example, since the measurement result of the terminal apparatus located near the center of an serving cell is generally better than the measurement result of the neighboring cell, there is a problem that handover or conditional handover based on a comparison between the quality of the serving cell and the quality of the neighboring cell is not likely to be performed. Therefore, it is needed to execute a forced handover procedure different from a normal procedure for each of these terminal apparatuses, and a temporary increase in the amount of signaling of the base station apparatus and a processing delay occur, and there is a problem that it is not possible to immediately transition to the NES mode and a power saving effect is reduced.

For this problem, for example, Non Patent Document 2 proposes a method for notifying the start of event evaluation of conditional handover using RRC signaling or a system information block (notification information, SIB). However, in the method of Non Patent Document 2, it is needed to newly add signaling used for notification, and it is needed for the terminal apparatus to monitor the signaling as needed. Therefore, operations of the base station apparatus and the terminal apparatus become complicated, but Non Patent Document 2 neither discloses nor suggests a solution to this problem.

Non Patent Document 3 proposes a method for performing handover before changing to the NES mode by reusing time-based conditional handover (CondEventT1). However, since the time-based conditional handover is performed without evaluating the quality of the handover destination candidate cell, there is a problem that there is no way to check whether the handover destination cell is the best cell for the terminal apparatus. However, Non Patent Document 3 neither discloses nor suggests a solution to this problem.

Hereinafter, embodiments will be described in detail with reference to the drawings. Problems and embodiments in the present specification are merely examples, and do not limit the scope of rights of the present application. In particular, the technology of the present application can be applied to even different expressions as long as the expressions are technically equivalent, and the scope of rights is not limited. The embodiments can be appropriately combined within a range in which the processing contents do not contradict each other.

A known technology may be appropriately used in a radio communication system according to the embodiments. The applicable known technique may be, for example, 5G (NR), Beyond 5G, 5G-Advanced, or other radio communication methods. The radio communication system according to the embodiments is applicable to NR, but is not limited thereto. For example, the embodiments are also applicable to long term evolution (LTE) and LTE-Advanced. Further, the present embodiment is also applicable to a radio communication system using NR as a part of the radio communication system.

Further, the embodiments are applicable to any radio communication system including at least a terminal apparatus and a base station apparatus, and are also applicable to future radio communication systems. In the following description, LTE and LTE-Advanced are also referred to as evolved universal terrestrial radio access (E-UTRA), but the meanings thereof are the same.

Embodiments of a base station apparatus, a terminal apparatus, and a radio communication system disclosed in the present application will be described below with reference to the drawings. Note that the following embodiments do not limit the disclosed technology.

### <Radio Communication System>

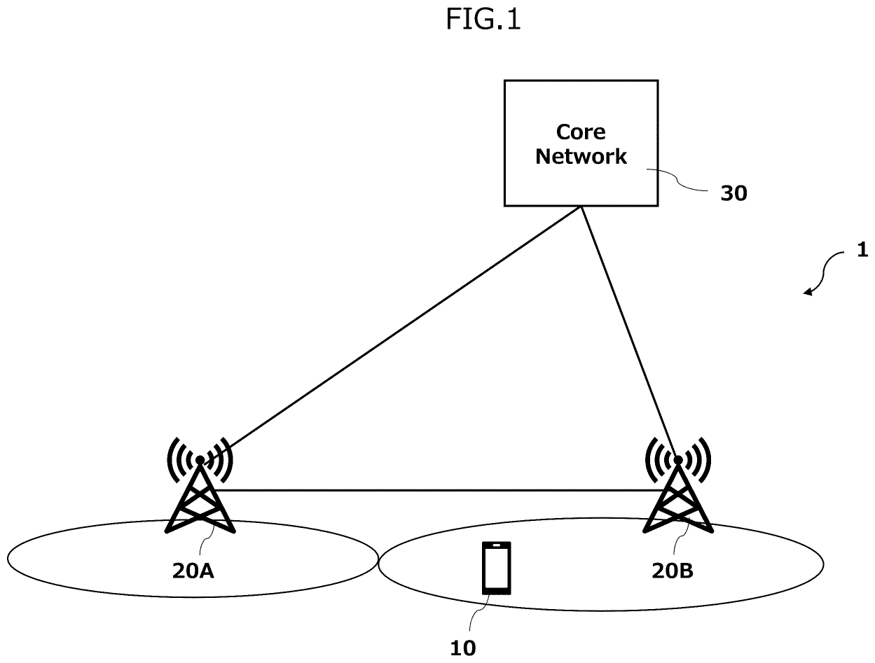

FIG. 1 is a diagram illustrating an example of a configuration of a radio communication system 1 according to embodiments. The radio communication system 1 according to the embodiments includes, for example, a terminal apparatus 10, base station apparatuses 20A and 20B, and a core network 30. Note that, in a case where the base station apparatuses 20A and 20B are not distinguished, they are simply referred to as a base station apparatus 20. Furthermore, a plurality of terminal apparatuses 10 may be provided.

The terminal apparatus 10 may be, for example, a wireless terminal such as various apparatuses and equipment (such as sensor apparatuses) having a radio communication function, such as a mobile phone, a smartphone, a personal digital assistant (PDA), a tablet, a wearable terminal, a personal computer, and a vehicle. Furthermore, the terminal apparatus 10 may be referred to as a radio communication apparatus, a communication apparatus, a reception apparatus, a mobile station, a user equipment (UE), a user apparatus, or the like.

A radio communication service is provided to the terminal apparatus 10 by the base station apparatus 20 and the core network 30 in the radio communication system 1. The core network 30 has functions such as management of service subscriber information, session management for a voice call, and location registration management of the terminal apparatus 10, for example. In addition, the core network 30 transmits control data and/or user data to the terminal apparatus 10 via the base station apparatus 20.

The core network 30 may be a 5G core (5GC) in 5G (NR) or an evolved packet core (EPC) in 4G (E-UTRA). Furthermore, a method for connection between the core network 30 and the base station apparatus 20 may be a non-stand alone (NSA) method or a stand alone (SA) method.

The 5G base station apparatus 20 connected to the 5GC is a gNB, and the 4G base station apparatus 20 connected to the EPC is an eNB. In addition, 5G base station apparatuses are connected by an Xn interface, and 4G base station apparatuses are connected by an X2 interface.

An area (coverage area) formed by the base station apparatus 20 may be referred to as a “cell”. E-UTRA and 5G are cellular communication systems constructed by a plurality of cells. As the radio communication system 1 according to the embodiments, either a time division duplex (TDD) scheme or a frequency division duplex (FDD) scheme may be applied, or a different scheme may be applied for each cell.

The base station apparatus 20 may be divided into, for example, a centralized unit (CU), a distributed unit (DU), and a radio unit (RU). The CU is connected to the core network. The DU is connected to the terminal apparatus 10 via, for example, the RU. A communication path between the CU and the DU is implemented by, for example, a fronthaul interface (F1 interface). Further, a plurality of DUs may be connected to one CU.

In the example illustrated in FIG. 1, data (downlink (DL) data) transmitted from the core network 30 to the terminal apparatus 10 is transmitted from the core network 30 to the base station apparatus 20, and is transmitted (transferred) from the base station apparatus 20 to the terminal apparatus 10.

Data (uplink (UL) data) transmitted from the terminal apparatus 10 to the core network 30 is transmitted from the terminal apparatus 10 to the base station apparatus 20, and is transmitted (transferred) from the base station apparatus 20 to the core network 30.

The terminal apparatus 10 and the base station apparatus 20 transmit and receive a radio resource control (RRC) message (also referred to as RRC signaling) in an RRC layer. In addition, the terminal apparatus 10 and the base station apparatus 20 transmit and receive a medium access control (MAC) control element (MAC CE) in an MAC layer.

The RRC message is transmitted as an RRC protocol data unit (RRC PDU), and a common control channel (CCCH), a dedicated control channel (DCCH), a paging control channel (PCCH), a broadcast control channel (BCCH), a multicast control channel (MCCH), or the like is used as a logical channel (LCH) to be mapped.

The MAC CE is transmitted as a MAC PDU (or a MAC subPDU). The MAC subPDU is equivalent to a service data unit (SDU) in the MAC layer with, for example, an 8-bit header, and the MAC PDU includes one or more MAC subPDUs.

Subsequently, as the physical channel and the physical signal according to the embodiment, at least a synchronization signal (Primary Synchronization Signal, Secondary Synchronization Signal), a physical broadcast channel (PBCH), a physical random access channel (PRACH), a physical downlink control channel (PDCCH), a channel state information-reference signal (CSI-RS), a physical uplink control channel (PUCCH), a physical downlink shared channel (PDSCH), a physical uplink shared channel (PUSCH), a scheduling reference signal (SRS), and a demodulation reference signal (DMRS) are present, but detailed description thereof is omitted.

### <Terminal Apparatus>

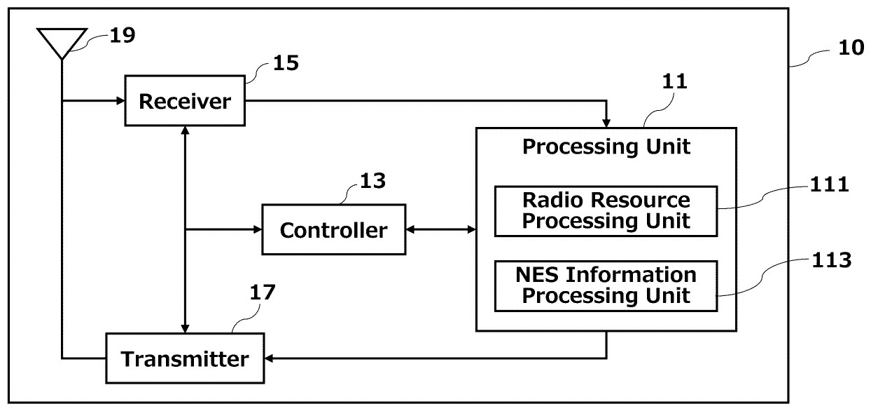

FIG. 2 is a diagram illustrating an example of a functional configuration of the terminal apparatus 10 according to one embodiment. As illustrated in FIG. 2, the terminal apparatus 10 includes, for example, a processing unit 11, a controller 13, a receiver 15, a transmitter 17, and a transmission/reception antenna unit 19. The processing unit 11 includes, for example, a radio resource processing unit 111 and an NES information processing unit 113. Note that the functional configuration of the terminal apparatus 10 illustrated in FIG. 2 is merely an example, and functional categories and names of functional blocks may be different as long as the operation according to the embodiment can be performed.

The processing unit 11 generates, for example, control information for controlling the receiver 15 and the transmitter 17, and outputs the control information to the controller 13. The processing unit 11 executes processing related to, for example, a radio resource control layer, a packet data convergence protocol (PDCP) layer, a radio link control (RLC) layer, and a medium access control layer.

The radio resource processing unit 111 manages various types of configuration information (RRC parameter and information element (IE)) of the terminal apparatus 10. For example, the radio resource processing unit 111 generates information to be placed on each physical uplink channel, and outputs the information to the transmitter 17. In addition, the radio resource processing unit 111 performs measurement of the serving cell and the neighboring cell, start and stop of transmission/reception processing, a DL synchronization procedure (cell search), a UL synchronization procedure (random access procedure), reacquisition of system information, event evaluation regarding handover, a series of processing related to handover, and the like based on an instruction from the base station apparatus 20.

The NES information processing unit 113 performs a processing procedure corresponding to NES-related configurations and parameter management. For example, the NES information processing unit 113 performs processing such as determining whether to perform evaluation of a measurement event in consideration of the NES mode, determining an application timing of a parameter related to the NES mode, and triggering condition handover in consideration of the NES mode. The NES information processing unit 113 determines whether to perform each procedure and determines the timing based on the RRC parameter (information element) provided via the radio resource processing unit 111, and provides the result as control information to the radio resource processing unit 111.

The controller 13 performs various types of control in the terminal apparatus 10. For example, the controller 13 generates a control signal or control data for controlling the receiver 15 and the transmitter 17 based on the control information received from the processing unit 11. In addition, the controller 13 controls uplink transmission to the base station apparatus 20 and downlink reception from the base station apparatus 20 based on information regarding discontinuous transmission and reception.

The receiver 15 separates, demodulates, and decodes various signals received from the base station apparatus 20 via the transmission/reception antenna unit 19 based on the control signal provided from the controller 13. The receiver 15 outputs decoded information to the processing unit 11.

The transmitter 17 generates, for example, a physical uplink signal based on the control signal provided from the controller 13, and performs encoding, modulation, and the like on the physical uplink signal or the physical uplink channel provided from the processing unit 11. The transmitter 17 multiplexes various signals and transmits the multiplexed signal to the base station apparatus 20 via the transmission/reception antenna unit 19.

Note that the processing unit 11 and the controller 13 are implemented by, for example, a processor system including a processor and a memory. In this case, the processor provides the functions of the processing unit 11 and the controller 13 by executing a program describing an operation of the terminal apparatus 10 described below. In addition, the processing unit 11 and the controller 13 may be implemented by one processor system or may be implemented by a plurality of processor systems. Alternatively, the processing unit 11 and the controller 13 may be implemented by a digital signal processor (DSP), a hardware circuit, or the like.

### <Base Station Apparatus>

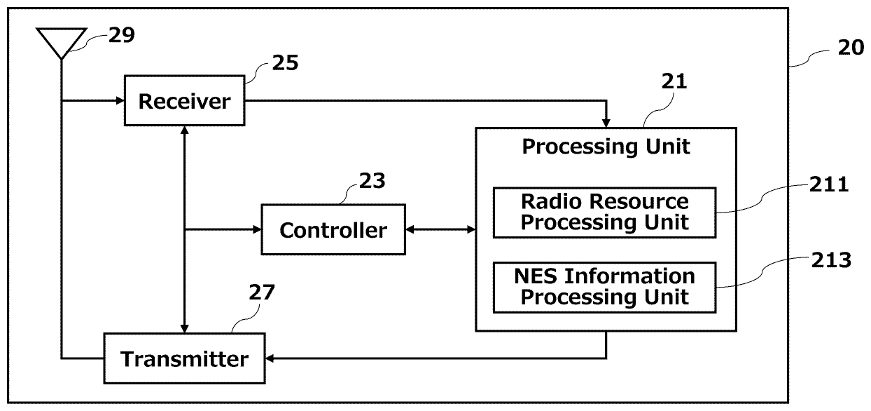

FIG. 3 is a diagram illustrating an example of a functional configuration of the base station apparatus 20 according to one embodiment. As illustrated in FIG. 3, the base station apparatus 20 includes, for example, a processing unit 21, a controller 23, a receiver 25, a transmitter 27, and a transmission/reception antenna unit 29. The processing unit 21 includes, for example, a radio resource processing unit 211 and an NES information processing unit 213. Note that the functional configuration of the base station apparatus 20 illustrated in FIG. 3 is merely an example, and functional categories and names of functional blocks may be different as long as the operation according to the embodiment can be performed.

The processing unit 21 generates, for example, control information for controlling the receiver 25 and the transmitter 27, and outputs the control information to the controller 23. The processing unit 21 executes processing related to, for example, a radio resource control layer, a packet data convergence protocol layer, a radio link control layer, and a medium access control layer.

The radio resource processing unit 211 generates, for example, downlink data, an RRC message, and a MAC control element to be placed on a physical downlink shared channel PDSCH, and outputs the downlink data, the RRC message, and the MAC control element to the transmitter 27. In addition, the radio resource processing unit 211 generates a control signal or control data to be placed on a physical downlink control channel PDCCH, and outputs the control signal or control data to the transmitter 27. Further, the radio resource processing unit 211 manages various types of configuration information of the terminal apparatus 10. The radio resource processing unit 211 executes start and stop of transmission/reception processing, start of a UL synchronization procedure (random access procedure), update of system information, adjustment of a beam transmission angle, cell configuration regarding handover, pre-configuration of a parameter regarding a measurement event type (measurement event identifier), and the like based on a notification by a signal or an RRC message from the terminal apparatus 10.

The NES information processing unit 213 performs a processing procedure corresponding to NES-related configurations and parameter management for the terminal apparatus 10. For example, the NES information processing unit 213 performs processing such as determination of whether to transition to the NES mode, generation of a parameter indicating evaluation of a measurement event in consideration of the NES mode, determination of an application timing of the parameter regarding the NES mode, and generation of a measurement event parameter of condition handover in consideration of the NES mode. The NES information processing unit 213 provides the determined timing and values of various parameters to the radio resource processing unit 211 as RRC parameters (information elements).

The controller 23 performs various types of control in the base station apparatus 20. For example, the controller 23 generates a control signal or control data for controlling the receiver 25 and the transmitter 27 based on the control information from the processing unit 21. Furthermore, the controller 23 controls downlink transmission to the terminal apparatus 10 and uplink reception from the terminal apparatus 10 based on information regarding discontinuous transmission and reception.

The receiver 25 separates, demodulates, and decodes various signals received from the terminal apparatus 10 or the core network 30 via the transmission/reception antenna unit 29 based on the control signal provided from the controller 23. The receiver 25 outputs the decoded information to the processing unit 21.

The transmitter 27 generates, for example, a downlink reference signal based on the control signal provided from the controller 23. The transmitter 27 performs encoding, modulation, multiplexing, and the like on various types of information provided from the processing unit 21, thereby transmitting a signal to the terminal apparatus 10 via the transmission/reception antenna unit 29.

In addition, the transmitter 27 transmits data to the terminal apparatus 10, another base station apparatus 20, or the core network 30. The receiver 25 receives data from the terminal apparatus 10, another base station apparatus 20, or the core network 30.

Note that the processing unit 21 and the controller 23 are implemented by, for example, a processor system including a processor and a memory. In this case, the processor provides the functions of the processing unit 21 and the controller 23 by executing a program describing an operation of the base station apparatus 20 described below. In addition, the processing unit 21 and the controller 23 may be implemented by one processor system or may be implemented by a plurality of processor systems. Alternatively, the processing unit 21 and the controller 23 may be implemented by a DSP, a hardware circuit, or the like.

### <Measurement Configuration/Measurement Report>

The base station apparatus 20 notifies (configure, specify, transmit) the terminal apparatus 10 of measurement configuration to cause the terminal apparatus 10 to measure the frequency (for example, NR and/or EUTRA frequency). Note that the measurement configuration is notified by, for example, an RRC message (for example, RRCReconfiguration).

The measurement configuration includes at least the following parameters.

(1) Measurement Object(s) The measurement object includes information regarding an object to be measured by the terminal apparatus 10, and a plurality of the measurement objects can be configured as a type of list. The base station apparatus 20 may indicate intra-frequency measurements, inter-frequency measurements, and inter-system EUTRA measurements (inter-RAT (Radio Access Technology) E-UTRA measurements) as measurement objects. In the case of inter-system EUTRA measurement, the EUTRA frequency is configured as a measurement object.

In addition, the base station apparatus 20 can include a list of cells to which a cell-specific offset is provided, a block cell list, and an allowed cell list in the measurement object. The cell-specific offset is an offset value added to a measurement result at the time of measurement, the block cell list is a list indicating cells that are not applicable (not covered) as event evaluation (described later) or a measurement report, and the allowed cell list is a list indicating cells that are applicable (covered) as event evaluation or a measurement report. In order to manage measurement objects, the base station apparatus 20 configures a measurement object identifier (measObjectId) for each measurement object.

### (2) Reporting Configuration(s)

The reporting configuration includes information related to a measurement report, and a plurality of reporting configurations are configured as one or a type of list for each measurement object. In order to manage the reporting configuration, the base station apparatus 20 configures a reporting configuration identifier (reportConfigId) for each reporting configuration.

### (3) Measurement Identity(ies)

The measurement identity (measId) is an identifier for linking (matching, associating) one measurement object identifier (measObjectId) and one reporting configuration identifier (reportConfigId). A plurality of measurement identities can be configured as a type of list. A plurality of reporting configurations may be linked to one measurement object by the measurement identity, or a plurality of measurement objects may be linked to the same reporting configuration. The measurement identity is included in the measurement report and transmitted to report the event fulfilling a trigger condition to the base station apparatus 20.

With respect to a measurement object related to NR, the terminal apparatus 10 measures and reports an serving cell (also referred to as a serving cell), a listed cell, and a detection cell. The listed cell is a cell included in the list notified from the base station apparatus 20. The detection cell indicates a cell detected by the other terminal apparatus 10 voluntarily.

The measurement event(s) to be evaluated by the terminal apparatus 10 is specified by the base station apparatus 20. The measurement event is specified in the reporting configuration and is managed by an event identifier (eventId). When the measurement event is triggered (fulfilled), the terminal apparatus 10 generates a measurement report message (Measurement Report) and transmits the measurement report message to the base station apparatus 20. The condition (measurement type) indicating the transmission trigger of the measurement report message is periodic report or event triggered report, and one of the conditions is specified by the base station apparatus 20.

A measurement object cell (applicable cell) to be evaluated for each measurement event is determined. For example, the measurement object cell for the event A1 is the serving cell. In addition, the measurement object cell for the event A3 is a cell (adjacent cell) detected at the measurement object frequency linked to the reporting configuration including the event A3.

The terminal apparatus 10 initiates the measurement report procedure when the measurement type is the event trigger report and the measurement result meets the condition indicated by the measurement event. In other words, the process is started when the measurement result of the measurement object cell fulfills (satisfies) the event condition corresponding to the event identifier specified in the reporting configuration included in the measurement configuration. At this time, the terminal apparatus 10 reports the measurement result of the cell corresponding to the measurement identity fulfilling the event condition (trigger condition).

### <Conditional Handover>

The terminal apparatus 10 in a connected state moves between the cells formed by the base station apparatus 20 using handover or conditional handover (CHO). In the conditional handover, the base station apparatus 20 notifies the terminal apparatus 10 in advance of cell configuration information specifying a candidate cell (target cell) of a handover destination and a trigger condition (measurement event type (measurement event, measurement report event)) of handover (conditional handover). The measurement event (trigger condition) specified in the conditional handover configuration is also referred to as an event condition (conditional event).

At this time, the base station apparatus 20 can configure a maximum of 8 candidate cells (that is, a maximum of eight candidate cells are configured) for the terminal apparatus 10. The terminal apparatus 10 measures the serving cell and the neighboring cell. In addition, the terminal apparatus 10 evaluates the measurement event based on the trigger condition notified from the base station apparatus 20. Hereinafter, one or a plurality of pieces of cell configuration information and the trigger condition are also collectively referred to as conditional handover configuration. The conditional handover configuration includes candidate cells and other necessary cell configurations and is specified in one or more list type formats. Here, the measurement object cell is a candidate cell included in the conditional handover configuration, and is identified by a physical cell identifier (PCI). In other words, the terminal apparatus 10 regards the cell having the physical cell identifier specified in the RRC message (RRCReconfiguration) included in the conditional handover configuration as the measurement object cell.

The base station apparatus 20 and the terminal apparatus 10 identify and manage conditional handover configurations by a handover condition reconfiguration identifier (CondReconfigId). The base station apparatus 20 and the terminal apparatus 10 may add, delete, or modify each conditional handover configuration corresponding to the handover condition reconfiguration identifier. In addition, the handover condition reconfiguration identifier (CondReconfigId) can specify the event condition by linking with the measurement identity (measId) included in the measurement configuration.

When the trigger condition is fulfilled (the conditional handover condition is fulfilled), the terminal apparatus 10 applies the cell configuration of the candidate cell corresponding to the measurement event as the handover destination cell. That is, after the conditional handover succeeds, the cell configuration corresponding to another cell is unnecessary. Therefore, the terminal apparatus in which the conditional handover succeeds autonomously deletes the cell configurations corresponding to the cell other than the destination cell.

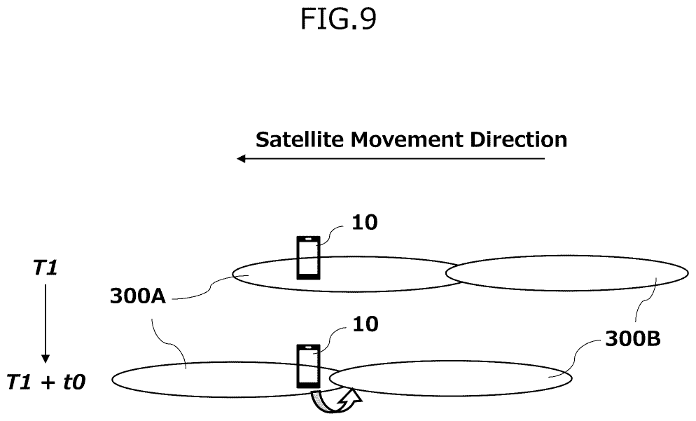

FIG. 9 is a diagram illustrating an example of a conditional handover event. The conditional handover event illustrated in FIG. 9 is a time-based measurement event, and is also referred to as an event condition T1 (ContEventT1). The event condition T1 is introduced as a measurement event for a non-terrestrial network (NTN). The terminal apparatus 10 measures a time from a certain reference time to the current time. Then, the terminal apparatus 10 evaluates the handover event by comparing the clocked time with a configured threshold value.

In the example illustrated in FIG. 9, the terminal apparatus 10 is located in a cell 300A. Then, the base station apparatus 20 (not illustrated) notifies the terminal apparatus 10 of elapsed time information (threshold value TH_t) and duration information (duration) from Jan. 1, 1980 of the Gregorian calendar as information regarding the event condition T1. The elapsed time information is notified in units of 10 milliseconds. The terminal apparatus 10 in which the event condition T1 is configured as the valid measurement event counts the current time (Mt) in units of milliseconds and starts comparison with the notified elapsed time information (threshold value TH_t). Then, when Mathematical Formula 1 is fulfilled, that is, when the current time exceeds the notified threshold value TH_t, the terminal apparatus 10 determines that the entering condition (event fulfillment condition) is fulfilled.

$$Mt > TH\_t \qquad [ Mathematical Formula 1 ]$$

When Mathematical Formula 2 is fulfilled, that is, when the current time Mt exceeds a value obtained by adding the duration information (duration) to the threshold value TH_t, the terminal apparatus 10 determines that the leaving condition (event leaving condition) is fulfilled. In the example illustrated in FIG. 9, the event condition T1 is not fulfilled in the terminal apparatus 10 at time T1. Thereafter, the event condition T1 is fulfilled at a time when the time t0 has elapsed from the time T1 (that is, time T1+t0>threshold value TH_t). In this case, the terminal apparatus 10 performs conditional handover to a pre-configured candidate cell (for example, cell 300B).

$$Mt > TH\_t + duration \qquad [ Mathematical Formula 2 ]$$

Another example of a conditional handover event is a quality-based event condition Ax (event condition A3, event condition A4, or event condition A5). Hereinafter, when described as the event condition Ax, it means that at least one of the event condition A3, the event condition A4, or the event condition A5 is used.

Here, the measurement quality of the serving cell is defined as Mp, the measurement quality of the neighboring cell is defined as Mn, the frequency offset corresponding to the serving frequency (frequency of the serving cell) is defined as Ofp, the frequency offset corresponding to the frequency of the neighboring cell is defined as Ofn, the cell-specific offset corresponding to the serving cell is defined as Ocp, the cell-specific offset corresponding to the neighboring cell is defined as Ocn, the event-specific offset value is defined as Off, the hysteresis value is defined as Hys, and the quality-based threshold value is defined as Thresh(Thresh1, Thresh2). The base station apparatus 20 transmits these parameters to the terminal apparatus 10 by using the RRC message as a part of the measurement configuration.

When the measurement result of the cell fulfills Mathematical Formula 3, the terminal apparatus 10 determines that the entering condition of the event condition A3 is fulfilled. Similarly, in a case where the measurement result fulfills Mathematical Formula 4, the terminal apparatus 10 determines that the leaving condition of the event condition A3 is fulfilled.

$$Mn + Ofn + Ocn - Hys > Mp + Ofp + Ocp + Off \qquad [ Mathematical Formula 3 ]$$

$$Mn + Ofn + Ocn + Hys < Mp + Ofp + Ocp + Off \qquad [ Mathematical Formula 4 ]$$

In addition, in a case where the measurement result of the cell fulfills Mathematical Formula 5, the terminal apparatus 10 determines that the entering condition of the event condition A4 is fulfilled. Similarly, in a case where the measurement result fulfills Mathematical Formula 6, the terminal apparatus 10 determines that the leaving condition of the event condition A4 is fulfilled.

$$Mn + Ofn + Ocn - Hys > Thresh \qquad [ Mathematical Formula 5 ]$$

$$Mn + Ofn + Ocn + Hys < Thresh \qquad [ Mathematical Formula 6 ]$$

In addition, in a case where the measurement result of the cell fulfills both Mathematical Formula 7 and Mathematical Formula 8, the terminal apparatus 10 determines that the entering condition of the event condition A5 is fulfilled. Similarly, in a case where the measurement result fulfills either Mathematical Formula 9 or Mathematical Formula 10, the terminal apparatus 10 determines that the leaving condition of the event condition A5 is fulfilled.

$$Mp + Hys < Thresh 1 \qquad [ Mathematical Formula 7 ]$$

$$Mn + Ofn + Ocn - Hys > Thresh 2 \qquad [ Mathematical Formula 8 ]$$

$$Mp - Hys > Thresh 1 \qquad [ Mathematical Formula 9 ]$$

$$Mn + Ofn + Ocn + Hys < Thresh 2 \qquad [ Mathematical Formula 10 ]$$

When configuring the event condition T1, the base station apparatus 20 simultaneously configures the event condition Ax. In other words, the base station apparatus 20 needs to configure the measurement identity linked to the event condition T1 and the event condition Ax in the terminal apparatus 10 as the handover condition reconfiguration identifier.

Embodiments will be described in detail below with reference to the accompanying drawings in consideration of the above matters. In the description of the embodiments, when it is determined that a specific description of a known function or configuration related to the embodiments makes the gist of the embodiments unclear, the detailed description thereof will be omitted.

### First Embodiment

The terminal apparatus 10 according to a first embodiment has an ability to execute conditional handover and an ability to measure a current time. The terminal apparatus 10 changes the parameter applied to the configured quality-based conditional handover from the related conditional handover configuration (first configuration) to the conditional handover configuration (second configuration) corresponding to the NES mode based on the entering condition (first condition) and the leaving condition (second condition) of the time-based conditional handover. The state in which the NES mode is turned off, that is, the cell state of the normal mode is an example of the first cell state. Further, the state in which the NES mode is turned on, that is, the cell state of the NES mode is an example of the second cell state. The normal mode is an example of the first mode, and the NES mode is an example of the second mode.

The base station apparatus 20 according to the first embodiment has an ability to execute conditional handover, an ability (function) to enable a power saving function in the NES mode, and an ability to generate a conditional handover configuration corresponding to the NES mode and notify the terminal apparatus 10 of the conditional handover configuration. The base station apparatus 20 determines the related conditional handover configuration (first configuration) and the conditional handover configuration (second configuration) corresponding to the NES mode as the parameter related to the entering condition (first condition) and the leaving condition (second condition) of the time-based conditional handover and the parameter applied to the quality-based conditional handover, and transmits the determined conditional handover configurations to the terminal apparatus 10.

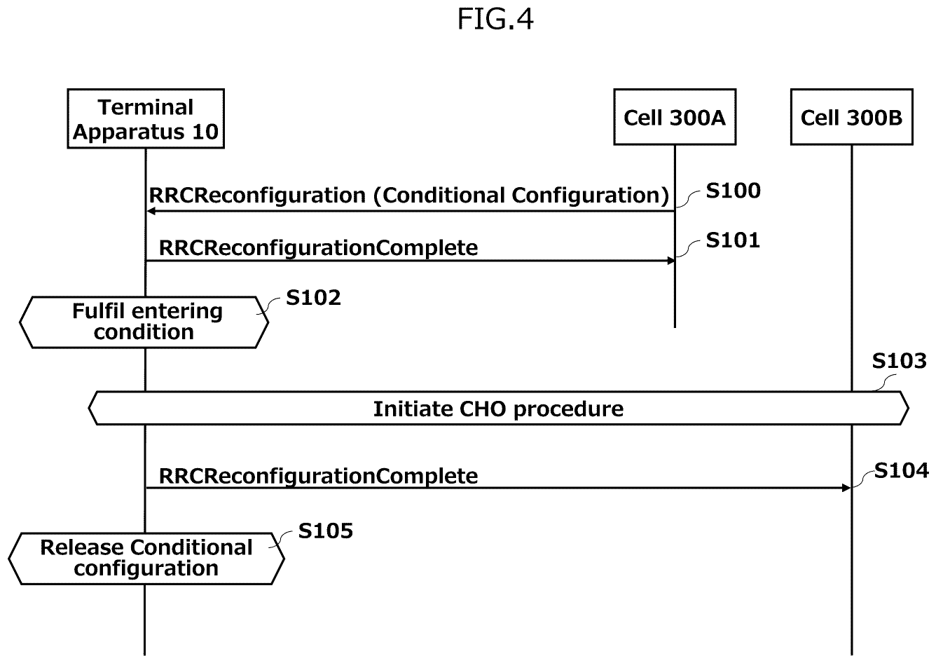

FIG. 4 is a diagram illustrating an example of a sequence according to the embodiment. The cell 300A is an serving cell of the terminal apparatus 10, and the cell 300B indicates the neighboring cell of the terminal apparatus 10 and one of the handover destination candidate cells (target cells).

The terminal apparatus 10 is connected to the base station apparatus 20 (not illustrated) via the cell 300A. The base station apparatus 20 starts the conditional handover procedure if needed based on the measurement result received from the terminal apparatus 10. Typically, handover preparation is requested to the base station apparatus 20 to which the notified cell (cell 300B) belongs, and information for accessing the cell 300B is exchanged between the base station apparatuses 20. Then, the base station apparatus 20 transmits an RRC message (RRCReconfiguration) including information needed for conditional handover to the terminal apparatus 10 (Step S100).

The terminal apparatus 10 receives the RRC message (RRCReconfiguration message) transmitted from the base station apparatus 20. The base station apparatus 20 may use an RRCSetup message or an RRCReestablishment message instead of the RRCReconfiguration message.

The base station apparatus 20 transmits the RRC message including the conditional handover configuration (Conditional configuration). In the example of FIG. 4, the base station apparatus 20 includes at least the trigger condition related to the NES mode and the cell configuration information of the cell 300B as the candidate cell in the conditional handover configuration and transmits the conditional handover configuration.

The terminal apparatus 10 determines that it is the trigger condition (measurement event) related to the NES mode based on the notified conditional handover configuration, and stores the corresponding candidate cell configuration. Then, a response message (RRCReconfigurationComplete message) of the received RRC message is generated and transmitted to the base station apparatus 20 (Step S101). The terminal apparatus 10 may use an RRCSetupComplete message or an RRCReestablishmentComplete message for the response based on the received RRC message.

Subsequently, the terminal apparatus 10 determines the target cell based on the received conditional handover configuration. The terminal apparatus 10 starts measurement of the handover candidate cell based on the measurement configuration included in the received RRC message. That is, the handover candidate cell notified is regarded as the measurement object cell (applicable cell(s)), and the evaluation of the measurement event is started. The terminal apparatus 10 starts the evaluation of the candidate cell at an appropriate timing according to the measurement event specified at the same time (described later). Then, when the configured predetermined measurement event is fulfilled (triggered) (Step S102), a conditional handover procedure is performed.

The terminal apparatus 10 attempts the conditional handover to the cell 300B that is the handover destination candidate cell corresponding to the triggered measurement event (Step S103). When the conditional handover is successful (that is, in a case where the synchronization acquisition and random access procedures are successful in the cell configuration of the applied cell 300B), the terminal apparatus 10 generates an RRC message (RRCReconfigurationComplete message) indicating that the conditional handover is successful, and transmits the RRC message to the base station apparatus 20 via the cell 300B (Step S104).

After transmitting the RRC message (RRCReconfigurationComplete message), the terminal apparatus 10 assumes that the conditional handover to the cell 300B has been successfully performed. In this case, when there is a conditional handover configuration other than the selected candidate cell (cell 300B), the terminal apparatus 10 deletes all the configurations of the remaining candidate cells (Step S105).

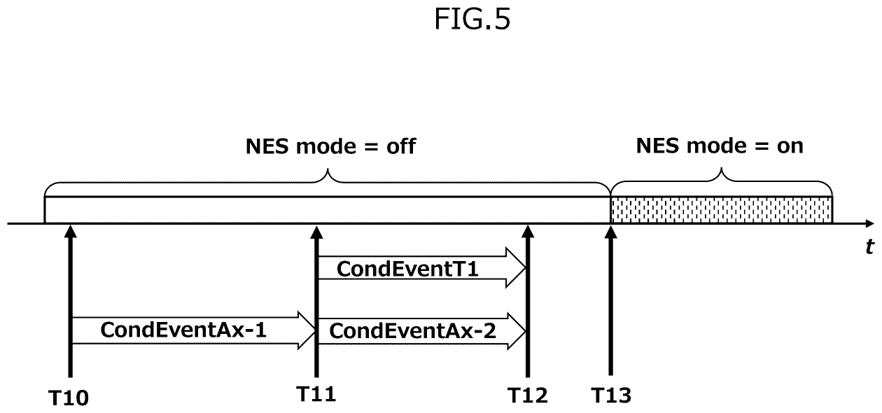

FIG. 5 is a diagram illustrating an example of event evaluation timing of conditional handover according to one embodiment. A horizontal axis in the figure indicates the passage of time. The upper part of FIG. 5 illustrates an NES mode of an serving cell, and the lower part conceptually illustrates a measurement event related to conditional handover applied by the terminal apparatus 10. The NES mode of the serving cell indicates that the NES mode starts from a state in which the NES mode is turned off (that is, a normal cell), and the NES mode is turned on at a time T13 (that is, the cell state becomes the power saving mode).

A time T10 indicates a timing at which the terminal apparatus 10 receives the RRC message (for example, RRCReconfiguration message) from the base station apparatus 20 of the serving cell. The RRC message includes at least the conditional handover configuration related to the NES mode and the candidate cell. Here, as a trigger condition of the conditional handover configuration, the base station apparatus 20 configures a time-based event condition T1 and a cell quality-based event condition Ax (CondEventAx-1 and CondEventAx-2 in the figure) in the terminal apparatus 10. The base station apparatus 20 includes the measurement identity specifying the event condition T1 and the event condition Ax in the conditional handover configuration identified by the same handover condition reconfiguration identifier.

The cell quality (received quality) is calculated by measuring a synchronization signal block (SSB) or a channel state information reference signal (CSI-RS). The cell quality can be expressed by using any of reference signal received power (RSRP), reference signal received quality (RSRQ), received signal strength indicator (RSSI), signal to interference plus noise ratio (SINR), and path loss.

The base station apparatus 20 configures, for the terminal apparatus 10, a measurement configuration for reporting the SSB identifier, the quality for each SSB, the cell quality based on the SSB, or the CSI-RS identifier, the quality for each CSI-RS resource, and the cell quality based on the CSI-RS resource.

Note that the normal conditional handover configuration applied to the event condition (trigger condition) is also referred to as the first configuration, and the conditional handover configuration corresponding to the NES mode applied to the event condition is also referred to as the second configuration.

When receiving the RRC message at the time T10, the terminal apparatus 10 checks whether the trigger condition related to the NES mode is included (configured) in the conditional handover configuration. More specifically, the terminal apparatus 10 checks whether information triggered by the measurement event at the leaving condition of the measurement event is configured and/or an offset value corresponding to the NES mode is configured for the configured quality-based event condition Ax in the configured time-based conditional handover (CondEventT1). Information that triggers CondEventT1 at the leaving condition of the measurement event is also referred to as leaving report information (ReportOnLeave).

Here, the leaving report information (ReportOnLeave) may be configured as a parameter applicable only in a case where the NES mode is supported, or may be configured as a general-purpose parameter including a change of the NES mode as one purpose. In addition, the names may be different.

When these pieces of information are configured, the terminal apparatus 10 determines that the corresponding conditional handover configuration requires evaluation of the measurement event in consideration of the NES mode of the serving cell. In other words, the base station apparatus 20 configures the information for triggering the measurement event at the leaving condition of the measurement event and/or the offset value corresponding to the NES mode for the quality-based event condition Ax for the time-based conditional handover (CondEventT1) at the time T10 and transmits the configuration to the terminal apparatus 10.

A time T11 indicates a timing at which the terminal apparatus 10 applies the trigger condition in consideration of the NES mode. The terminal apparatus 10 determines that when the entering condition of the configured time-based conditional handover (CondEventT1) is fulfilled, in other words, the timing at which Mathematical Formula 1 is fulfilled, is the time T11. That is, the base station apparatus 20 implicitly notifies the terminal apparatus 10 of the timing to apply the trigger condition considering the NES mode by CondEventT1, the leaving report information (ReportOnLeave), and the related threshold value (TH_t). Note that the time T11 is an example of the first time.

A period from the time T10 to the time T11 is a period in which the trigger condition considering the NES mode is not applied, and the terminal apparatus 10 evaluates the normal event condition Ax (CondEventAx-1 in the figure) based on the measured cell quality. That is, the terminal apparatus 10 performs the quality-based event evaluation using the related Mathematical Formula 3 to Mathematical Formula 10 based on the configured event condition. Note that the normal event condition Ax (CondEventAx-1 in the figure) is an example of the first event condition.

The terminal apparatus 10 applies the trigger condition considering the NES mode at the time T1l. Specifically, the base station apparatus 20 applies the NES mode offset Off_nes, which is an additional parameter, to the event condition Ax and starts evaluation of the event condition Ax (CondEventAx-2 in the figure) in consideration of the NES mode. The terminal apparatus 10 may start an RRC timer at the time T11 in order to measure the time during which the NES mode offset Off_nes is applied. Here, the RRC timer is set to the same value as the parameter duration of the duration information related to CondEventT1. Note that the event condition Ax (CondEventAx-2 in the figure) considering the NES mode is an example of a second event condition.

For example, in a case where the event condition A3 is configured, the terminal apparatus 10 evaluates the measurement event using Mathematical Formula 11 and Mathematical Formula 12 from the time T1l. In a case where the measurement result fulfills Mathematical Formula 11, the terminal apparatus 10 determines that the entering condition of the event condition A3 considering the NES mode is fulfilled. Similarly, in a case where the measurement result fulfills Mathematical Formula 12, the terminal apparatus 10 determines that the leaving condition of the event condition A3 considering the NES mode is fulfilled.

$$Mn + Ofn + Ocn - Hys + Off\_nes > Mp + Ofp + Ocp + Off \qquad [ Mathematical Formula 11 ]$$

$$Mn + Ofn + Ocn + Hys + Off\_nes < Mp + Ofp + Ocp + Off \qquad [ Mathematical Formula 12 ]$$

Furthermore, for example, in a case where the event condition A4 is configured, the terminal apparatus 10 evaluates the measurement event using Mathematical Formula 13 and Mathematical Formula 14 from the time T1l. In a case where the measurement result fulfills Mathematical Formula 13, the terminal apparatus 10 determines that the entering condition of the event condition A4 considering the NES mode is fulfilled. Similarly, in a case where the measurement result fulfills Mathematical Formula 14, the terminal apparatus 10 determines that the leaving condition of the event condition A4 considering the NES mode is fulfilled.

$$Mn + Ofn + Ocn - Hys + Off\_nes > Thresh \qquad [ Mathematical Formula 13 ]$$

$$Mn + Ofn + Ocn + Hys + Off\_nes < Thresh \qquad [ Mathematical Formula 14 ]$$

Furthermore, for example, in a case where the event condition A5 is configured, the terminal apparatus 10 evaluates the measurement event by using Mathematical Formula 15 to Mathematical Formula 18 from the time T1l. When the measurement result fulfills both Mathematical Formula 15 and Mathematical Formula 16, the terminal apparatus 10 determines that the entering condition of the event condition A5 considering the NES mode is fulfilled. Similarly, in a case where the measurement result fulfills either Mathematical Formula 17 or Mathematical Formula 18, the terminal apparatus 10 determines that the leaving condition of the event condition A5 considering the NES mode is fulfilled.

$$Mp + Hys < Thresh 1 \qquad [ Mathematical Formula 15 ]$$

$$Mn + Ofn + Ocn - Hys + Off\_nes > Thresh 2 \qquad [ Mathematical Formula 16 ]$$

$$Mp - Hys > Thresh 1 \qquad [ Mathematical Formula 17 ]$$

$$Mn + Ofn + Ocn + Hys + Off\_nes < Thresh 2 \qquad [ Mathematical Formula 18 ]$$

Note that the application method for the parameter of the event condition Ax (CondEventAx-2) in consideration of the NES mode may be a method other than the method described above as long as the method makes it easier to fulfill the entering condition than the related event condition Ax. For example, a negative offset may be added to lower the threshold value (Thresh, Thresh1, Thresh2), or another more relaxed threshold value may be used for the evaluation of the event. For example, with respect to a cell-specific offset (Ocn, Ocp), an offset Ocp_nes having a value lower than Ocp may be applied instead, or an offset Ocn_nes of a neighboring cell having a value higher than Ocn may be applied instead. In addition, application methods for these parameters described above may be appropriately combined.

In a case where any of the event conditions Ax (CondEventAx-2) considering the NES mode is fulfilled, the terminal apparatus 10 stops the RRC timer if the RRC timer is running and simultaneously stops the evaluation of the event condition T1 (CondEventT1).

A time T12 indicates a timing at which the leaving condition of the time-based event condition T1 is fulfilled. The terminal apparatus 10 determines that when the configured leaving condition of the time-based conditional handover (CondEventT1) is fulfilled, in other words, the timing at which Mathematical Formula 2 is fulfilled, is the time T12. Note that, in a case where the RRC timer is running, the terminal apparatus 10 may regard the time when the RRC timer expires as the time T12. The terminal apparatus 10 cancels the event condition Ax (CondEventAx-2) considering the NES mode at the time T12 and triggers CondEventT1. Then, the terminal apparatus 10 starts the conditional handover procedure based on the candidate cell configuration corresponding to CondEventT1. Note that CondEventT1 is an example of the third event condition. The time T12 is an example of the second time.

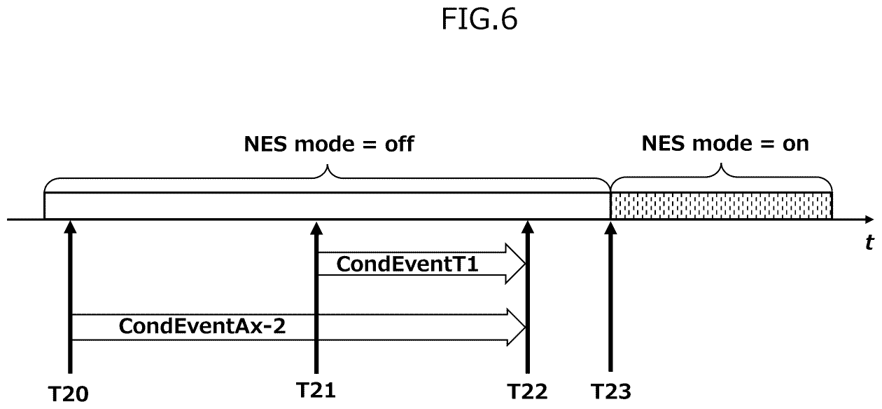

FIG. 6 is a diagram illustrating another example of the event evaluation timing of the conditional handover according to one embodiment. Hereinafter, the description of portions common to FIG. 5 will be omitted, and portions different from FIG. 5 will be described. The NES mode of the serving cell indicates that the NES mode starts from a state in which the NES mode is turned off (that is, a normal cell), and the NES mode is turned on at a time T23.

A time T20 indicates a timing at which the terminal apparatus 10 receives the RRC message (for example, the RRCReconfiguration message) from the base station apparatus 20 of the serving cell. The RRC message includes at least the conditional handover configuration related to the NES mode and the candidate cell. Here, as a trigger condition of the conditional handover configuration, the base station apparatus 20 configures the time-based event condition T1 and the cell quality-based event condition Ax (for example, CondEventAx-2 in FIG. 6) in the terminal apparatus 10. The base station apparatus 20 includes the measurement identity specifying the event condition T1 and the event condition Ax in the conditional handover configuration identified by the same handover condition reconfiguration identifier.

A procedure and a method in which the terminal apparatus 10 checks whether the trigger condition related to the NES mode is included (configured) in the conditional handover configuration may be the same as those in FIG. 5. At the time T20, the base station apparatus 20 configures the leaving report information (ReportOnLeave) for the time-based conditional handover (CondEventT1) and/or the offset value corresponding to the NES mode for the quality-based event condition Ax, and transmits the configuration to the terminal apparatus 10.

A time T21 indicates a timing at which the terminal apparatus 10 enables the trigger of the quality-based event condition Ax (CondEventAx-2) considering the NES mode and determines that the conditional handover procedure can be performed. The terminal apparatus 10 determines that when the entering condition of the configured time-based conditional handover (CondEventT1) is fulfilled, in other words, the timing at which Mathematical Formula 1 is fulfilled, is the time T21. That is, the base station apparatus 20 implicitly notifies the terminal apparatus 10 of the timing at which the conditional handover procedure considering the NES mode can be executed by CondEventT1, the leaving report information (ReportOnLeave), and the related threshold value (TH_t).

At the timing of the time T20, the terminal apparatus 10 starts evaluating the event condition Ax (CondEventAx-2) in consideration of the NES mode. The terminal apparatus 10 performs the quality-based event evaluation using, for example, Mathematical Formula 11 to Mathematical Formula 18 based on the configured event condition. However, the terminal apparatus 10 determines not to start the conditional handover procedure even when the event condition Ax (CondEventAx-2) is fulfilled (triggered) between the times T20 and T21.

Meanwhile, in a case where the event condition Ax (CondEventAx-2) is fulfilled (triggered) at or after the time T21, the terminal apparatus 10 determines that the conditional handover procedure can be performed. Note that the terminal apparatus 10 may suspend the fulfilled conditional handover procedure and resume the conditional handover procedure at or after the time T21. Note that the time T21 is an example of the first time.

A time T22 indicates a timing at which the leaving condition of the time-based event condition T1 is fulfilled. The terminal apparatus 10 determines that when the configured leaving condition of the time-based conditional handover (CondEventT1) is fulfilled, in other words, the timing at which Mathematical Formula 2 is fulfilled is the time T22. The terminal apparatus 10 cancels the event condition Ax (CondEventAx-2) considering the NES mode at the time T22 and triggers CondEventT1. Then, the terminal apparatus 10 starts the conditional handover procedure based on the candidate cell configuration corresponding to CondEventT1. Note that the time T22 is an example of the second time.

Since the event condition T1 is a measurement event for a non-terrestrial network (NTN), the terminal apparatus 10 notifies the base station apparatus 20 of information indicating that the terminal apparatus 10 is not compatible with the NTN but supports the event condition T1 using the terminal apparatus capability (UE capability). In addition, the terminal apparatus 10 may notify the base station apparatus 20 of information indicating that the modified event condition T1 (that is, evaluation is performed by applying the leaving report information (ReportOnLeave) to the event condition T1) is supported. This information may be implicitly indicated by notifying 1-bit information indicating support of conditional handover considering the NES mode. In addition, the terminal apparatus 10 that supports conditional handover in consideration of the NES mode may add a restriction that requires support of the event condition T1.

When the conditional handover fails or when the radio link failure occurs because the communication is hardly continued due to the degradation of the cell quality of the serving cell, and when the conditional handover configuration in consideration of the NES mode is notified, the terminal apparatus 10 may exclude a predetermined cell(s) matching the condition and try the reconnection (RRC reconnection, RRC Re-establishment) procedure. The base station apparatus 20 may transmit information indicating permission of an attempt of a reconnection procedure excluding the predetermined cell to the terminal apparatus 10 as a part of the conditional handover configuration.

In a case where the reconnection procedure is tried, the terminal apparatus 10 may exclude the serving cell before reconnection as a predetermined cell. Alternatively, the terminal apparatus 10 may exclude the serving cell before reconnection and after fulfilling the entering condition of the event condition T1 as a predetermined cell. In other words, the terminal apparatus 10 determines whether the serving cell before reconnection can be selected as the cell of the reconnection destination based on whether the entering condition of the event condition T1 is fulfilled.

In addition, in a case where the leaving report information (ReportOnLeave) is configured, the terminal apparatus 10 may exclude, as a predetermined cell, the serving cell before reconnection and after fulfilling the leaving condition of the event condition T1. In other words, the terminal apparatus 10 determines whether the serving cell before reconnection can be selected as the cell of the reconnection destination based on whether the leaving condition of the event condition T1 is fulfilled. The terminal apparatus 10 can reuse the conditional handover configuration and exclude the cell in the NES mode not suitable for stay from the cell of the reconnection destination by applying these determinations to the reconnection procedure. Note that the terminal apparatus 10 may delete the conditional handover configuration corresponding to the predetermined cell instead of excluding the predetermined cell.

When selecting, as the cell of the reconnection destination, a cell which is other than the excluded cell and which matches the cell (applicable cell) indicated by the conditional handover configuration, the terminal apparatus 10 reuses the conditional handover configuration and starts the reconnection procedure. That is, the terminal apparatus 10 regards the matched conditional handover configuration as the cell configuration of the reconnection destination.

In addition, the terminal apparatus 10 may directly trigger the measurement event based on L1 signaling (for example, PDCCH) or L2 signaling (for example, the MAC CE) indicating the trigger of an event condition regardless of the current time (timer) or the quality of the cell, or may activate the suspended measurement configuration or measurement report.

As described above, according to the first embodiment, the start timing of the event evaluation of the conditional handover in consideration of the NES mode can be notified using the entering condition of the related time-based measurement event. Therefore, the terminal apparatus 10 can perform the conditional handover in consideration of the NES mode at an appropriate timing without newly receiving a signal related to notification of timing from the base station apparatus 20. The base station apparatus 20 can prevent a decrease in user experience due to the change of the NES mode, and can efficiently perform movement control of the terminal apparatus 10. That is, it is possible to optimize each of the movement control methods of the base station apparatus 20 and the terminal apparatus 10 that support the NES. In addition, the efficiency of the NES can be improved.

### Second Embodiment

A second embodiment will be described. The second embodiment illustrates a method for performing conditional handover considering the NES mode without using the time-based event condition T1. Note that description of configurations, functions, or procedures common to the first embodiment and the second embodiment will be omitted. That is, points different from the first embodiment will be mainly described below.

The terminal apparatus 10 according to the second embodiment has an ability to execute the conditional handover and an ability to measure the current time. The terminal apparatus 10 applies the conditional handover configuration (second configuration) corresponding to the NES mode based on the current time.

The base station apparatus 20 according to the second embodiment has the ability to execute the conditional handover, an ability to enable a power saving function in the NES mode, and an ability to generate a conditional handover configuration corresponding to the NES mode and notify the terminal apparatus 10 of the conditional handover configuration. The base station apparatus 20 determines the parameter of the conditional handover configuration (second configuration) corresponding to the NES mode based on the time for transitioning the state of the cell to the NES mode, and transmits the parameter to the terminal apparatus 10.

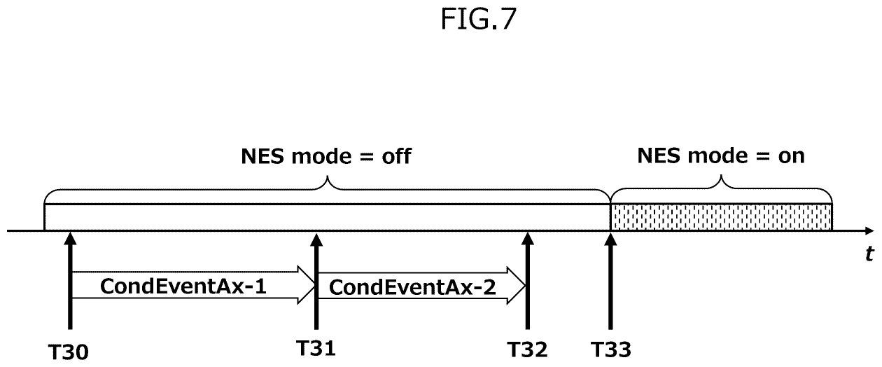

FIG. 7 is a diagram illustrating another example of the event evaluation timing of the conditional handover according to one embodiment. Hereinafter, the description of portions common to FIG. 5 will be omitted, and portions different from FIG. 5 will be described. The NES mode of the serving cell indicates that the NES mode starts from a state in which the NES mode is turned off (that is, a normal cell), and the NES mode is turned on at a time T33.

A time T30 indicates a timing at which the terminal apparatus 10 receives the RRC message (for example, the RRCReconfiguration message) from the base station apparatus 20 of the serving cell. The RRC message includes at least the conditional handover configuration related to the NES mode and the candidate cell. Here, as a trigger condition of the conditional handover configuration, the base station apparatus 20 configures a cell quality-based event condition Ax in the terminal apparatus 10.

The terminal apparatus 10 checks whether the trigger condition related to the NES mode is included (configured) in the conditional handover configuration. More specifically, the terminal apparatus 10 checks whether the time-based offset value corresponding to the NES mode and the timing information for applying the offset value are configured for the configured quality-based event condition Ax. The timing (the timing information) for applying the time-based offset value may be, for example, information indicated in the Gregorian calendar such as the event condition T1, or information indicating an elapsed time starting from the time T30.

When these pieces of information are configured, the terminal apparatus 10 determines that the corresponding conditional handover configuration requires evaluation of the measurement event in consideration of the NES mode of the serving cell. In other words, at the time T30, the base station apparatus 20 separately configures the time-based offset value corresponding to the NES mode for the quality-based event condition Ax and transmits the configured time-based offset value to the terminal apparatus 10.

A time T31 indicates a timing at which the terminal apparatus 10 applies the time-based trigger condition considering the NES mode. The terminal apparatus 10 determines that the timing at which the specified time has elapsed is the time T31. That is, the base station apparatus 20 notifies the terminal apparatus 10 of timing information for applying the trigger condition in consideration of the NES mode.

A period from the time T30 to the time T31 is a period in which the trigger condition considering the NES mode is not applied, and the terminal apparatus 10 evaluates a normal event condition Ax (CondEventAx-1) based on the measured cell quality. That is, the terminal apparatus 10 performs the quality-based event evaluation using the related Mathematical Formula 3 to Mathematical Formula 10 based on the configured event condition.

The terminal apparatus 10 applies the trigger condition considering the NES mode at the time T31. Specifically, the base station apparatus 20 applies the NES mode offset Off_nes, which is an additional parameter, to the event condition Ax and starts evaluation of the event condition Ax (CondEventAx-2) in consideration of the NES mode. Note that the time T31 is an example of the first time.

At the timing of the time T31, the terminal apparatus 10 starts evaluating the event condition Ax (CondEventAx-2) in consideration of the NES mode. The terminal apparatus 10 performs the quality-based event evaluation using, for example, Mathematical Formula 11 to Mathematical Formula 18 based on the configured event condition.

A time T32 indicates a timing at which the application time of the NES mode offset Off_nes ends. The terminal apparatus 10 stops applying the event condition Ax (CondEventAx-2) considering the NES mode at the time T32. At or after the time T32, the terminal apparatus 10 may start evaluating the related event condition Ax (CondEventAx-1), or may forcibly trigger CondEventAx at the timing of the time T32 and start the conditional handover procedure based on the candidate cell configuration corresponding to CondEventAx. Note that the time T32 is an example of the second time.

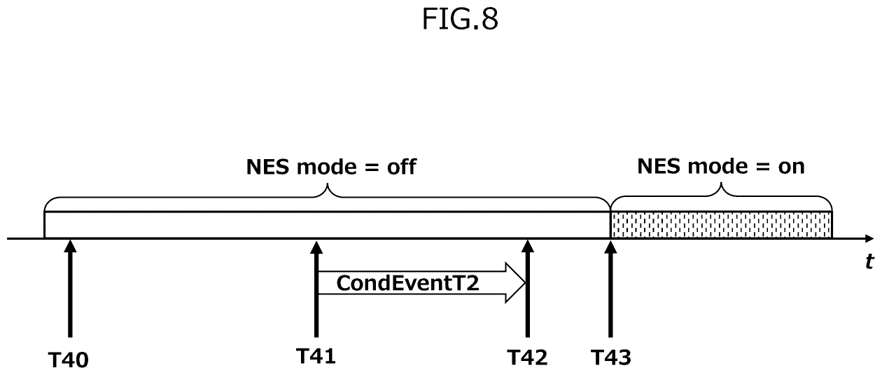

FIG. 8 is a diagram illustrating another example of the event evaluation timing of the conditional handover according to one embodiment. Hereinafter, the description of portions common to FIG. 5 will be omitted, and portions different from FIG. 5 will be described. The NES mode of the serving cell indicates that the NES mode starts from a state in which the NES mode is turned off (that is, a normal cell), and the NES mode is turned on at a time T43.

A time T40 indicates a timing at which the terminal apparatus 10 receives the RRC message (for example, the RRCReconfiguration message) from the base station apparatus 20 of the serving cell. The RRC message includes at least the conditional handover configuration related to the NES mode and the candidate cell. Here, as the trigger condition of the conditional handover configuration, the base station apparatus 20 configures a time-based event condition T2 in the terminal apparatus 10.

The event condition T2 is obtained by adding a condition related to the neighboring cell quality to the time-based event condition T1. For example, in a case where both Mathematical Formula 1 and Mathematical Formula 5 are fulfilled, the terminal apparatus 10 determines that the entering condition of the event condition T2 considering the NES mode is fulfilled. Similarly, in a case where either Mathematical Formula 2 or Mathematical Formula 6 is fulfilled, the terminal apparatus 10 determines that the leaving condition of the event condition T2 considering the NES mode is fulfilled. Alternatively, in a case where Mathematical Formula 2 is fulfilled, the terminal apparatus 10 may determine that the leaving condition of the event condition T2 considering the NES mode is fulfilled.

The terminal apparatus 10 determines whether the trigger condition related to the NES mode is included (configured) in the conditional handover configuration based on whether the event condition T2 is configured. The base station apparatus 20 configures the leaving report information (ReportOnLeave) for the time-based conditional handover (CondEventT2 in the figure) at the time T40 and transmits the leaving report information to the terminal apparatus 10.

The terminal apparatus 10 determines that when the entering condition of the configured time-based conditional handover (CondEventT2) is fulfilled, in other words, the timing at which Mathematical Formula 1 and Mathematical Formula 5 are fulfilled, is a time T41. That is, the base station apparatus 20 implicitly notifies the terminal apparatus 10 of the timing at which the conditional handover procedure considering the NES mode can be executed by CondEventT2, the leaving report information (ReportOnLeave), and the related threshold value (TH_t). Note that the time T41 is an example of the first time.

A time T42 indicates a timing at which the leaving condition of the time-based event condition T2 is fulfilled. In a case where the configured leaving condition of the time-based conditional handover (CondEventT2) is fulfilled, the terminal apparatus 10 determines that the fulfilled timing is the time T42. The terminal apparatus 10 triggers CondEventT2 at time T42. Then, the terminal apparatus 10 starts the conditional handover procedure based on the candidate cell configuration corresponding to CondEventT2. Note that the time T42 is an example of the second time.

As described above, according to the second embodiment, the start timing of the event evaluation of the conditional handover in consideration of the NES mode can be notified using the time-based parameter or the time-based measurement event in consideration of the cell quality. Therefore, the terminal apparatus 10 can perform the conditional handover in consideration of the NES mode at an appropriate timing without newly receiving a signal related to notification of timing from the base station apparatus 20. The base station apparatus 20 can prevent a decrease in user experience due to the change of the NES mode, and can efficiently perform movement control of the terminal apparatus 10. That is, it is possible to optimize each of the movement control methods of the base station apparatus 20 and the terminal apparatus 10 that support the NES. In addition, the efficiency of the NES can be improved.

Note that each of the above-described embodiments is for facilitating understanding of the present embodiment, and is not intended to limit the present embodiment. The present embodiment can be modified and improved without departing from the gist thereof, and the present embodiment includes equivalents thereof. For example, the event condition Ax (CondEventAx-2) considering the NES mode does not need to be configured, and the applied event condition may be switched to another linked event condition instead of switching the parameter of the event condition. Specifically, the event condition A3 may be switched to the event condition A4.

<Hardware Configuration of Each Apparatus in Each Embodiment>

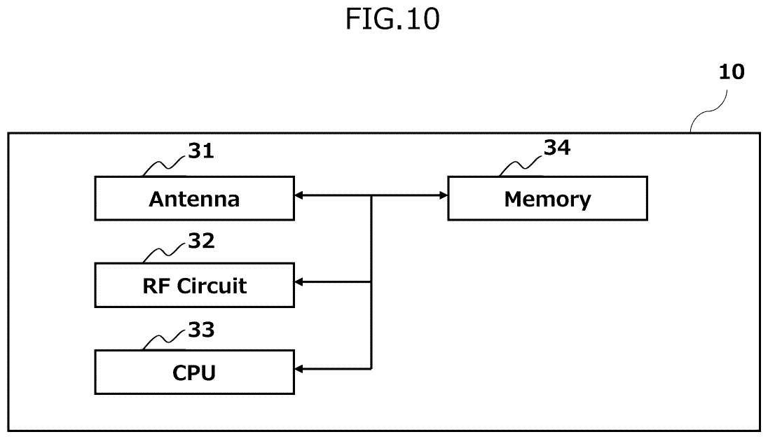

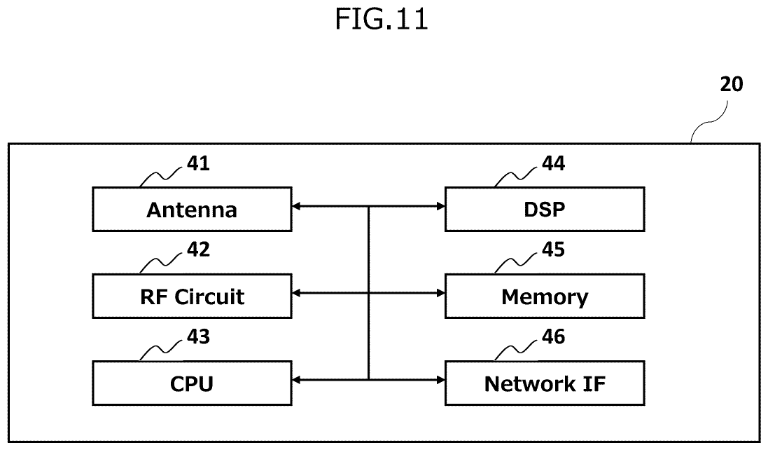

A hardware configuration of each apparatus in the radio communication system 1 of each embodiment will be described with reference to FIGS. 10 and 11.

FIG. 10 is a diagram illustrating an example of a hardware configuration of the terminal apparatus 10. As illustrated in FIG. 10, the terminal apparatus 10 includes, for example, a radio frequency (RF) circuit 32 including an antenna 31, a central processing unit (CPU) 33, and a memory 34 as hardware components. Furthermore, the terminal apparatus 10 may include a display apparatus such as a liquid crystal display (LCD) connected to the CPU 33. The memory 34 includes, for example, at least one of a random access memory (RAN) such as a synchronous dynamic random access memory (SDRAM), a read only memory (ROM), and a flash memory, and stores a program, control information, and a data signal.

The correspondence between the functional configuration of the terminal apparatus 10 illustrated in FIG. 2 and the hardware configuration of the terminal apparatus 10 illustrated in FIG. 10 will be described. The transmission/reception antenna unit 19, the transmitter 17, and the receiver 15 are realized by, for example, the RF circuit 32, or the antenna 31 and the RF circuit 32. The controller 13 and the processing unit 11 are realized by, for example, the CPU 33, the memory 34, a digital electronic circuit (not illustrated), and the like. Examples of the digital electronic circuit include an application specific integrated circuit (ASIC), a field programmable gate array (FPGA), and a large scale integration (LSI).

FIG. 11 is a diagram illustrating an example of a hardware configuration of the base station apparatus 20. As illustrated in FIG. 11, the base station apparatus 20 includes, for example, an RF circuit 42 including an antenna 41, a CPU 43, a DSP 44, a memory 45, and a network interface (IF) 46 as hardware components. The CPU 43 is connected via a bus so as to be able to input and output various signals and data signals. The memory 45 includes, for example, at least one of a RAM such as an SDRAM, a ROM, and a flash memory, and stores a program, control information, and a data signal.

The correspondence between the functional configuration of the base station apparatus 20 illustrated in FIG. 3 and the hardware configuration of the base station apparatus 20 illustrated in FIG. 11 will be described. The transmission/reception antenna unit 29, the transmitter 27, and the receiver 25 are realized by, for example, the RF circuit 42, or the antenna 41 and the RF circuit 42. The controller 23 and the processing unit 21 are implemented by, for example, the CPU 43, the DSP 44, the memory 45, a digital electronic circuit (not illustrated), and the like. Examples of the digital electronic circuit include an ASIC, an FPGA, and an LSI.

According to the above aspect, it is possible to optimize each of movement control methods of a base station apparatus and a terminal apparatus that support a technology for network energy savings (NES), and improve efficiency of network energy savings.

Throughout the descriptions, the indefinite article “a” or “an”, or adjective “one” does not exclude a plurality.

All examples and conditional language recited herein are intended for the pedagogical purposes of aiding the reader in understanding the disclosure and the concepts contributed by the inventor to further the art, and are not to be construed limitations to such specifically recited examples and conditions, nor does the organization of such examples in the specification relate to a showing of the superiority and inferiority of the disclosure. Although one or more embodiments of the present disclosures have been described in detail, it should be understood that the various changes, substitutions, and alterations could be made hereto without departing from the spirit and scope of the disclosure.

What is claimed is:

1. A terminal apparatus that communicates with a base station apparatus, the terminal apparatus comprising:
a controller configured to perform control corresponding to a first cell state that is a first mode and a second cell state that is a second mode different from the first mode; and
a receiver configured to receive information regarding a second condition that is a condition indicating that a third event condition is no longer fulfilled in a case of a second time at which a predetermined duration has elapsed from a first time from the base station apparatus,
wherein the receiver receives a PDCCH notifying of validation of the third event condition from the base station apparatus, and
the controller controls to
perform evaluation of a first event condition of conditional handover corresponding to the first cell state until a first condition that the PDCCH is received is fulfilled, and
perform evaluation of a second event condition of conditional handover corresponding to the second cell state in addition to the evaluation of the first event condition when the first condition is fulfilled.

2. The terminal apparatus according to claim 1, wherein the second cell state is a power saving mode for reducing power consumption of a cell.

3. The terminal apparatus according to claim 1, wherein each of measurement identities that specify the first event condition and the second event condition is included in a conditional handover configuration identified by a same handover condition reconfiguration identifier.

4. The terminal apparatus according to claim 1, wherein the controller is configured to evaluate the second event condition of the conditional handover by applying a parameter related to the second cell state to the first event condition when the first condition is fulfilled.

5. The terminal apparatus according to claim 1, wherein the controller is configured to control to start a conditional handover procedure when the first condition is fulfilled and the second event condition is fulfilled.

6. The terminal apparatus according to claim 1, wherein the controller is configured to perform an RRC reconnection procedure by excluding a predetermined cell when the RRC reconnection procedure using conditional handover configuration is performed in a case where information indicating permission of the RRC reconnection procedure based on the conditional handover configuration corresponding to the second cell state is notified.

7. A base station apparatus that communicates with a terminal apparatus, the base station apparatus comprising:
a controller configured to perform control corresponding to a first cell state that is a first mode and a second cell state that is a second mode different from the first mode; and
a transmitter configured to transmit information regarding a second condition that is a condition indicating that a third event condition is no longer fulfilled in a case of a second time at which a predetermined duration has elapsed from a first time from the base station apparatus,
wherein the transmitter transmits a PDCCH notifying of validation of the third event condition, and
the controller controls the terminal apparatus to perform evaluation of a first event condition of conditional handover corresponding to the first cell state until a first condition that the PDCCH is received is fulfilled, and perform evaluation of a second event condition of conditional handover corresponding to the second cell state in addition to the evaluation of the first event condition when the first condition is fulfilled.

8. The base station apparatus according to claim 7, wherein the second cell state is a power saving mode for reducing power consumption of a cell.

9. The base station apparatus according to claim 7, wherein each of measurement identities that specify the first event condition and the second event condition is included in a conditional handover configuration identified by a same handover condition reconfiguration identifier.

10. The base station apparatus according to claim 7, wherein the transmitter is configured to provide, to the terminal apparatus, information for evaluating the second event condition of the conditional handover by applying a parameter related to the second cell state to the first event condition in a case where the first condition is fulfilled.

11. The base station apparatus according to claim 7, wherein the transmitter is configured to provide information for starting a conditional handover procedure to the terminal apparatus in a case where the first condition is fulfilled and the second event condition is fulfilled.

12. The base station apparatus according to claim 7, wherein the transmitter is configured to notify the terminal apparatus of information indicating permission of an RRC reconnection procedure in which a predetermined cell is excluded based on conditional handover configuration corresponding to the second cell state, in a case where the RRC reconnection procedure is performed using the conditional handover configuration.

13. A handover control method executed in a terminal apparatus that communicates with a base station apparatus, the handover control method comprising:
performing control corresponding to a first cell state that is a first mode and a second cell state that is a second mode different from the first mode;
receiving information regarding a second condition that is a condition indicating that a third event condition is no longer fulfilled in a case of a second time at which a predetermined duration has elapsed from a first time from the base station apparatus;
receiving a PDCCH notifying of validation of the third event condition from the base station apparatus; and
controlling to perform evaluation of a first event condition of conditional handover corresponding to the first cell state until a first condition that the PDCCH is received is fulfilled, and perform evaluation of a second event condition of conditional handover corresponding to the second cell state in addition to the evaluation of the first event condition when the first condition is fulfilled.
